(19) United States
(12) Patent Application Publication
(10) Pub. No.: US 2005/0263330 A1
(43) Pub. Date: Dec. 1, 2005

(54) Field-oriented control for brushless DC motor

(75) Inventors: Thomas James Gallagher, Lake Orion, MI (US); Hong Jiang, Lake Orion, MI (US); Sergei Kolomeitsev, Rochester, MI (US); John R. Suriano, Auburn Hills, MI (US); Joseph P. Whinnery, Pontiac, MI (US)

Correspondence Address: JACOX, MECKSTROTH & JENKINS, 2310 Far Hills Building, Dayton, OH, 45419-1575, US

(73) Assignee: VALEO ELECTRICAL SYSTEMS, INC., AUBURN HILLS, MI (US)

(21) Appl. No.: 10/857,237

(22) Filed: May 28, 2004

(51) Int. Cl. B60K 1/00

(52) U.S. Cl. 180/65.1

(57) ABSTRACT

A control system for a brushless DC motor, preferably used in a power steering system in a vehicle. Presently delivered torque is computed without measuring currents in the motor. A demanded torque signal is received, and a torque error signal is produced. The torque error signal is modified by an inertial torque component, if the motor is accelerating. In response to the modified error signal, the control system first attempts to increase motor torque by increasing motor voltage, if that is possible, without increasing magnetic field which is parallel with the magnetic field of the rotor. If that is not possible, then motor voltage is held fixed, and the magnetic field just mentioned is increased.

The invention concerns a control system for brushless DC motors, wherein torque is measured for purposes of controlling stator current, without direct measurement of the stator currents. The invention also provides a two-tier stratagem for increasing torque produced by the motor.

### BACKGROUND OF THE INVENTION

FIG. 1 illustrates schematically three stator coils 3, 6, and 9, which are contained in a three-phase synchronous motor (not shown). FIG. 2 shows the coils, but with connecting wires W of FIG. 1 omitted, to avoid clutter. In FIG. 2, currents I3, I6, and I9 are generated in the respective coils. Each current produces a magnetic field B3, B6, and B9, as indicated.

The coils 3, 6, and 9 are physically positioned to be 120 degrees apart, as shown, so that the fields B3, B6, and B9 are also positioned 120 degrees apart physically (as opposed to chronologically). This arrangement allows creation of a magnetic field which rotates in space at a constant speed, if proper currents are generated in the coils, as will now be explained.

FIG. 3 illustrates three-phase currents. The vertical axis on the coordinates runs from negative unity to positive unity for simplicity. In practice, one would multiply the values of unity by the actual peak-to-peak values of the currents being used.

The horizontal axis represents time, but measured in degrees. For example, if the frequency of the sine waves is 60 Hz, then 360 degrees represent 1/60 seconds, or 16.7 milliseconds. One degree represents 16.7/360, or 0.046 milliseconds.

Currents in the form of sine waves SIN3, SIN6, and SIN9 are created respectively in coils 3, 6, and 9, as indicated. The sine waves are separated by 120 chronological, or electrical, degrees. Coil 3 resides at zero physical degrees. SIN3 begins at zero degrees on the time axis, as indicated on the plot.

Similarly, coil 6 stands at 120 degrees from coil 3. SIN6 begins at 120 degrees, as indicated on the plot. Similarly, coil 9 stands at 240 degrees from coil 3. Correspondingly, SIN9 begins at 240 degrees, as indicated on the plot.

Each coil 3, 6, and 9 produces a magnetic field, as indicated. Those three magnetic fields add vectorially to produce a single magnetic field, which rotates at a constant angular velocity, if the sine waves SIN3, SIN6, and SIN9 have the same peak-to-peak magnitudes, and are exactly 120 degrees apart in phase.

FIG. 4 represents the vector sum B of magnetic fields B3, B6, and B9 of FIG. 2. Vector B in FIG. 4 rotates in the direction of arrow 30.

FIG. 5 shows the coils of FIGS. 1-3 superimposed over the rotating vector B. In addition, the rotor ROT of the motor is shown. Rotor ROT contains an apparatus which generates a rotor magnetic field BR. The apparatus may take the form of a permanent magnet PM.

The rotor field BR continually attempts to align itself with the rotating vector B, thus causing the rotor ROT to rotate. Controlling the speed of the rotating vector B, by controlling the individual vectors B3, B6, and B9 in FIG. 2, by controlling the currents 13, 16, and 19, allows one to control speed of the motor.

FIG. 6 illustrates one type of prior-art control system, termed a “field oriented” control system. The overall task is to compute the current needed to deliver the torque demanded by the input 79 to summer 80. Then, modulator PWM generates the appropriate currents, analogous to those in FIG. 3, which are delivered to the three coils in the motor. However, to simplify computation, translator 64 converts measurement of the sinusoidal instantaneous phase currents Iᵤ and Iᵥ into two equivalent direct currents I_{d} and I_{q}, which rotate in space along with the rotor. After intermediate computations are performed to produce voltages Vq and Vd, a reverse transformation is undertaken by translator 95, to generate three equivalent sinusoidal voltages Vᵤ and Vᵥ and V_{w}.

Explaining this in greater detail, a Pulse Width Modulator PWM synthesizes three sinusoidal currents Iu, Iv, and Iw, which correspond in concept to currents I3, I6, and I8 in FIG. 2. Sensors 50 and 52 measure currents Iu and Iv. This measurement of two currents allows computation of the third current, Iw, because the three currents must sum to zero, because the COILS are Y-connected.

Image 60 illustrates the spatial orientations of the three currents. (It is perhaps more accurate to speak of spatial orientation of the magnetic fields which the currents produce, but it has become customary to refer to spatial orientation of the currents, since the magnetic fields and the currents are closely related.) Image 63 illustrates vector addition of the three currents, producing a vector sum, Isum.

In one approach, Isum, or the individual currents Iu, Iv, and Iw directly, are used in later computations which derive parameters the PWM needs to compute the necessary currents to generate in each of the COILS. However, such computations require extensive computer power.

Another approach which requires less computation is to transform the rotating vector Isum into a stationary reference frame. This is done by block 64, together with encoder 65. The latter measures the present angle theta of the rotor, shown above the encoder 65.

Image 68 represents the rotating current Isum, but enlarged compared with image 60. Image 72 superimposes a conventional rotating coordinate system, with axes labeled “d” (direct) and “q” (quadrature). This coordinate system is rotated by the angle theta. The angle of the coordinate system, of course, will continually change, as theta changes.

Block 64 computes two coordinates, Id (I-direct) and Iq (I-quadrature) in the rotating coordinate system. These currents Id and Iq add vectorially to the current Isum, as do currents Iu, Iv, and Iw. However, the currents Id and Iq possess the advantage of being in a coordinate system which is superimposed on the rotor, and is thus stationary with respect to the rotor.

The d-axis is aligned with the magnetic field of the rotor. Maximum torque is obtained when the stator field is aligned 90 degrees with the rotor field, that is, along the q-axis. Thus, Iq indicates the current which provides maximum torque.

The currents Id and Iq are fed to summers 80 and 83. Demanded torque is fed to summer 80, and the output of summer 80 is an error signal E1, indicating deviation (if any) of Iq from demanded torque. A signal of zero is fed to summer 83, which produces an error signal E2, indicating deviation of Id from zero. That is, at this time, Id is demanded to be zero, and error signal E2 indicates whether Id meets that demand.

Proportional-Integral (PI) controllers 90 and 93 compute voltages Vd and Vq which must be generated to produce the hypothetical currents Id and Iq. Reference frame translator 95 performs the reverse of translator 64. Translator 95 computes three needed voltages Vu, Vv, and Vw which are needed to produce the three currents Iu, Iv, and Iw.

Stated another way, voltages Vq and Vd are two orthogonal voltage vectors which sum to a certain voltage sum vector. Translator 95 computes three voltage vectors Vu, Vv, and Vw, which are not orthogonal but separated by 120 degrees, which sum to the same voltage sum vector.

Block PWM produces output voltages corresponding to Vu, Vv, and Vw resulting in currents Iu, Iv, and Iw.

The present invention offers certain improvements to the control system of FIG. 6.

### OBJECTS OF THE INVENTION

An object of the invention is to provide an improved control system for a brushless DC motor wherein response of the control system is improved by inertial compensation.

Another object of the invention is to provide an improved control system wherein field-oriented control is implemented, but without measuring stator currents.

### SUMMARY OF THE INVENTION

In one form of the invention, a demanded torque is received. The inertial torque is computed from the measured rotor acceleration and summed with the demand torque to produce a torque error signal. The torque error is reduced by correcting the voltage magnitude and phase angle. Indirect current sensing is used to estimate the actual motor current and torque so that the new voltage parameters can be computed. The indirect current sensing is based on known motor parameters along with rotor speed and position measurement.

### BRIEF DESCRIPTION OF THE DRAWINGS

FIG. 1 illustrates coils in a three-phase motor of the prior art.

FIG. 2 illustrates magnetic field vectors generated by the three coils.

FIG. 3 illustrates three-phase currents applied to the coils of FIGS. 1 and 2.

FIG. 4 illustrates the rotating vector sum B of the three magnetic fields of FIG. 2.

FIG. 5 illustrates the coils of FIGS. 1-3 and the rotor of a motor superimposed over FIG. 5.

FIG. 6 is a schematic of a field-oriented control system for a three-phase motor.

FIG. 7 illustrates one form of the invention.

FIG. 8 illustrates equations utilized by one form of the invention.

FIG. 9 illustrates processes undertaken by one form of the invention.

FIGS. 10 and 11 illustrate a two-phase electric motor having a permanent magnet rotor.

FIG. 12 illustrates generally the phase relations among the voltage V in FIG. 12, and the components EMF and I.

FIG. 13 illustrates the waveforms of FIG. 12 in phasor format. It is observed in FIGS. 12 and 13 that the magnitudes shown are arbitrary. Also, by convention, phasors in FIG. 13 rotate counterclockwise. In addition, time in FIG. 12 refers to elapsed time, from a time of zero. Thus, point P2 occurred before P1, which occurred before P. Angles alpha and delta in FIG. 12 correspond to the same angles in FIG. 13.

FIG. 14 illustrates one form of the invention.

FIG. 15 illustrates an alternate form of the invention using indirect current sensing and inertial torque feedback.

FIG. 16 illustrates an alternative form of the invention using a proportional-integral controller to minimize torque error.

FIG. 17 illustrates an alternative implementation of the voltage calculator utilizing rotationally transformed d and q current and voltage variables.

FIG. 18 illustrates an alternative implementation of the torque calculator utilizing rotationally transformed d and q current and voltage variables.

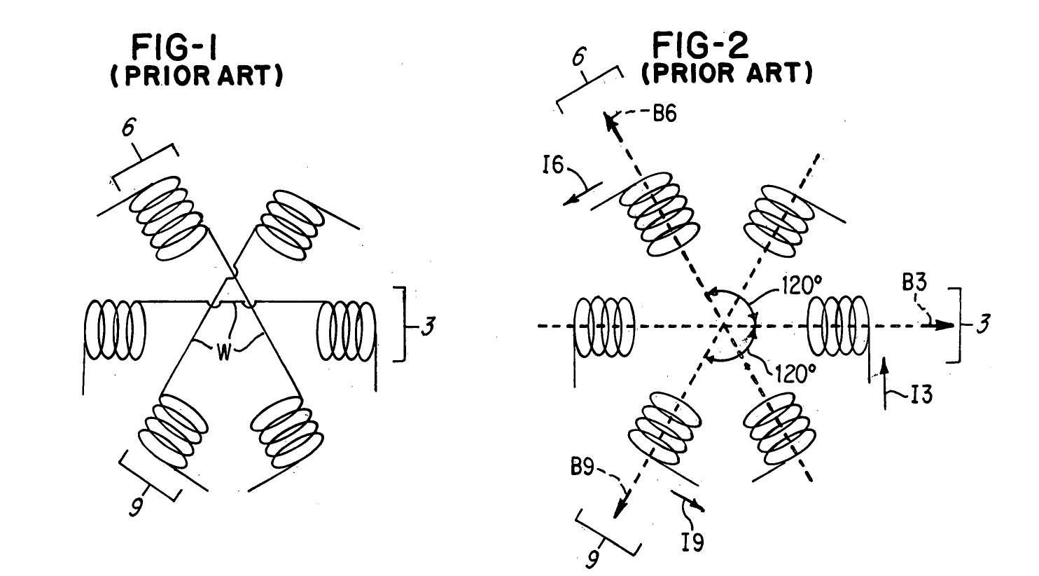

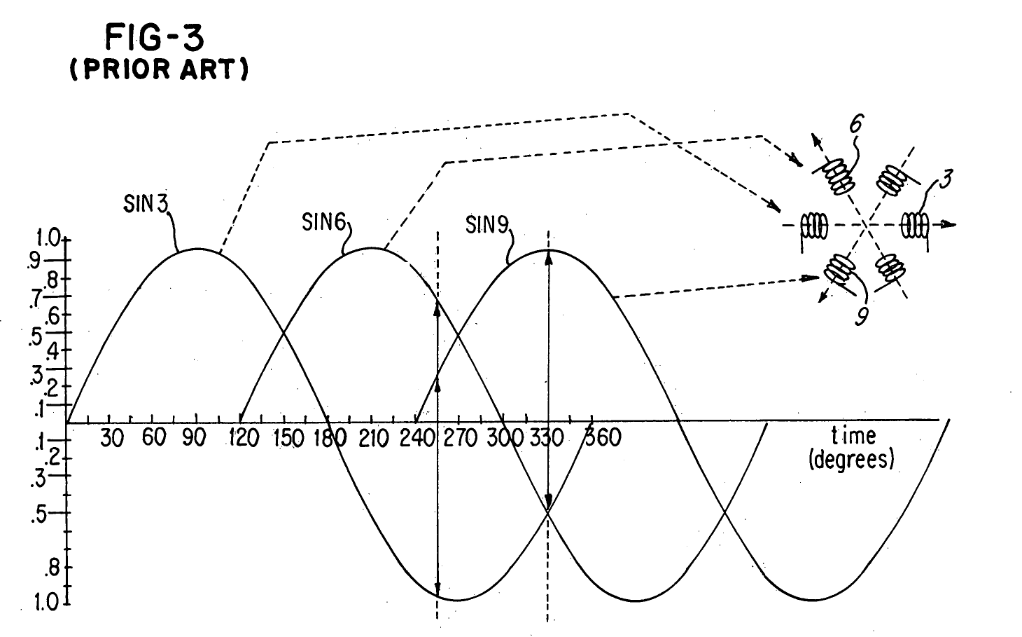

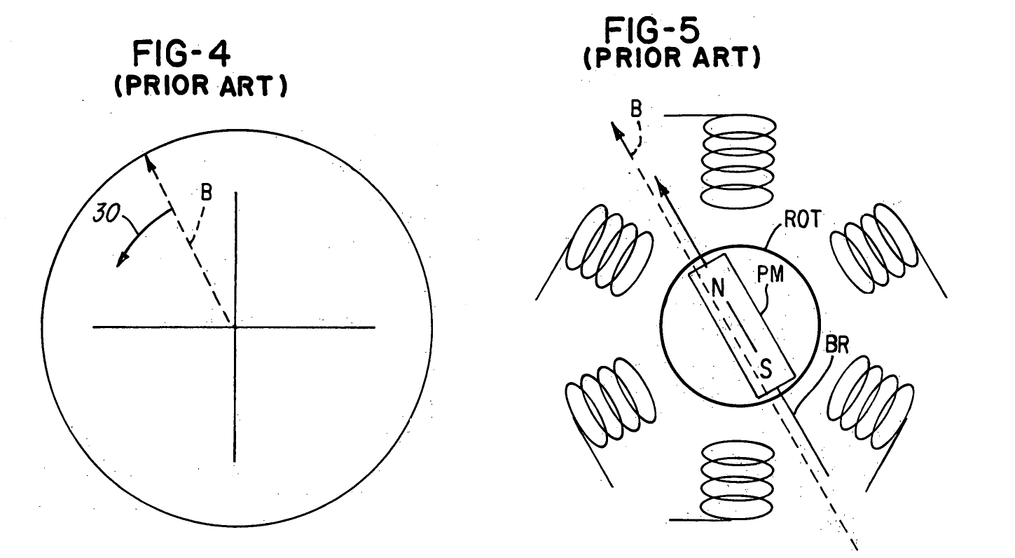

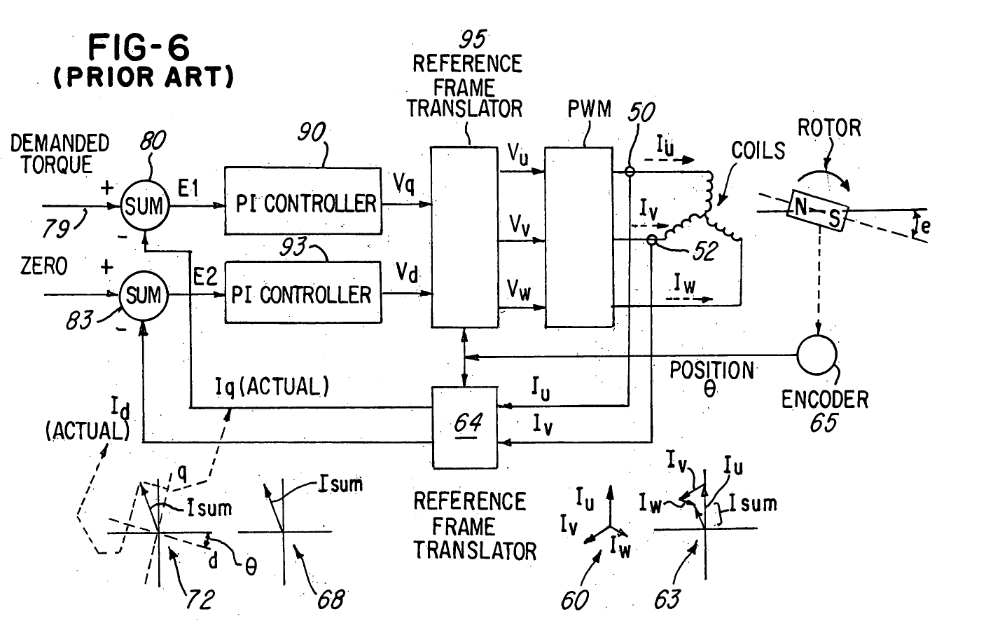

### DETAILED DESCRIPTION OF THE INVENTION

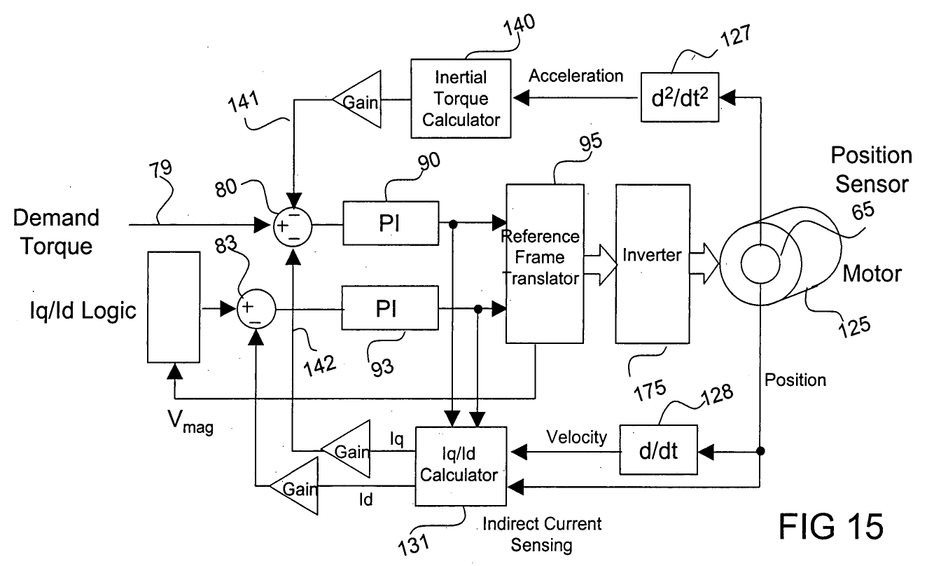

FIG. 15 is a block diagram of one form of the invention. Motor 120 can be of the two-phase brushless DC type, and can be used in a power steering system in a vehicle 300 in FIG. 14. Block 125 in FIG. 15 represents a detection apparatus, such as an encoder or resoIver and its associated computation circuitry. Position output is converted into velocity and acceleration signals by differentiators 127 and 128.

FIG. 15 represents an improvement over the prior art FIG. 6 in two ways. First, the current sensors 50 are replaced by indirect current sensing by using calculator 131 to compute the d and q axis current components from voltage, speed, position, and known motor parameters. The indirect current sensing represents a steady state estimate of the actual current.

FIG. 15 incorporates a second improvement over prior art FIG. 6 in that it incorporates inertial compensation in the formation of the torque error signal by summer 80. The torque error signal is comprised of a demand torque signal 79, an estimate of the torque 142 computed from the calculation of Iq, and a calculation of the inertial acceleration torque 141. The inclusion of the inertial torque term estimates torque produced by the motor which may not be included in the steady state estimate of the current in block 131 and thereby serves to improve stability of the system as explained below.

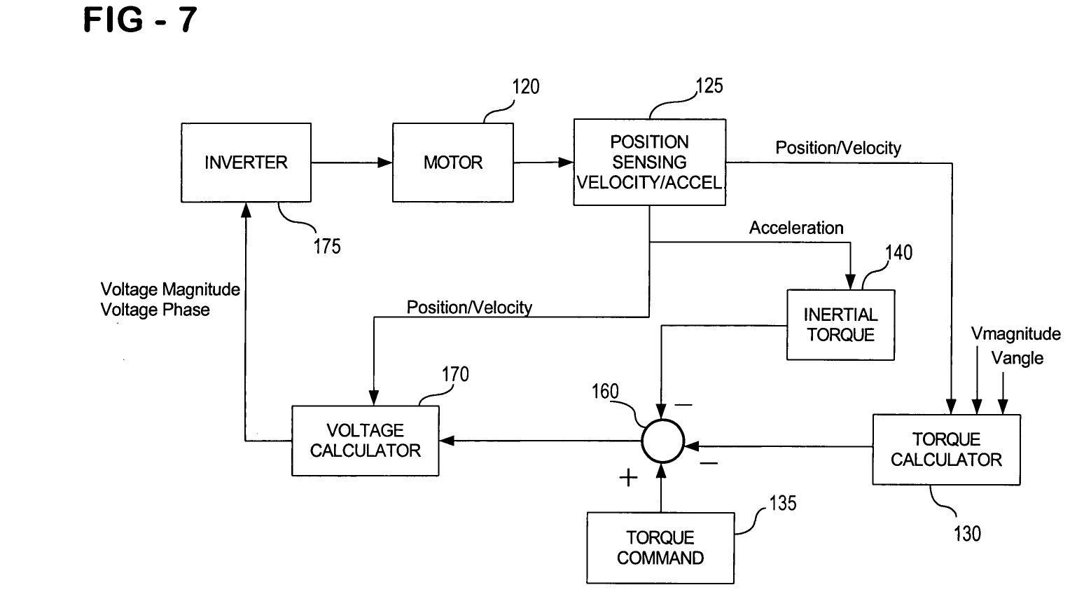

FIG. 7 is a block diagram of another form of the invention. Motor 120 can be of the two-phase brushless DC type, and can be used in a power steering system in a vehicle 300 in FIG. 14. Block 125 in FIG. 7 represents a detection apparatus, such as an encoder or resoIver and its associated computation circuitry, which computes angular position of the motor. Based on the first time-derivative of angular position, block 125 computes motor speed. Based on the second time-derivative, block 125 computes motor acceleration.

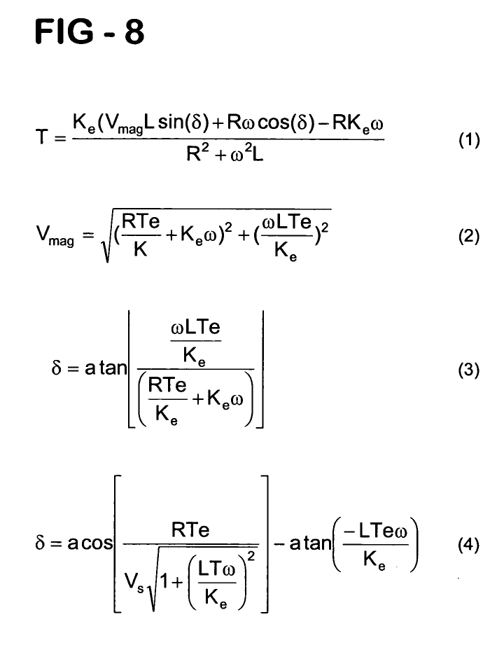

Speed and velocity, together with the present voltages applied to the motor (angle and phase), are fed to block 130, which computes torque presently delivered by the motor. Rather than direct measurement of current with sensors 50 of prior art FIG. 6, or indirect current sensing 131 of FIG. 15, Equation 1 in FIG. 8 computes the torque directly from measured speed and motor parameters. Viewed another way, Equation 1 of FIG. 8 incorporates indirect current sensing in the steady state motor equations to predict the torque from measured speed and velocity together with known motor parameters. This torque is modified by an inertial torque, if the motor is accelerating, as explained below.

Ke is a constant, which depends on the characteristics of the motor in question, and Ke is known in the art. Ke, multiplied by rotor speed in radians per second, gives the EMF discussed below. Ke indicates the degree of magnetic coupling between the rotor magnet and a coil, as well as the number of turns of the coil, if the latter is considered distinct from degree of coupling.

In equation 1, ωm refers to mechanical rotor speed.

In FIG. 7, block 135 indicates a demanded torque signal is received. The demanded torque signal is produced by apparatus external to the invention. In the case of a power steering system, demanded torque would be derived in a manner known in the art, based on driver torque sensor output, steering wheel position and vehicle speed.

Block 140 computes an inertial torque, based on present acceleration, if any, of the rotor in the motor. The inertial torque, if present, increases the amount of electrical energy required to be delivered to the motor, and is perhaps more easily explained in linear-motion terms, as opposed to a rotational system like the motor 120.

One horsepower equals 550 foot-pounds per second. If 550 pounds are being raised one foot every second, then one horsepower is being developed. The force of 550 pounds is analogous to torque in the motor 120.

If, over ten seconds, the speed of lifting is increased from one foot per second to ten feet per second, then at the end of ten seconds, ten horsepower are being developed. However, during that ten seconds, the velocity of the object has increased from one foot per second to ten feet per second. The kinetic energy of the object, (½)mass×square of velocity, has increased from 275 to 27,500 pound-feet-squared/second-squared. Additional energy must be added during the acceleration to provide for the increase in kinetic energy.

The inertial torque of FIG. 7 is similar to that additional energy, but in a rotating frame of reference.

The three torque signals are added in summer 160. The output of the summer 160 is an error signal. The summer computes the error between the torque command and a summation of inertial and estimated motor output torque. The negative sign on summer 160 indicates that the torque error is reduced when the inertial torque is positive, during acceleration. This effectively reduces the torque required from the motor during acceleration. A positive sign, adding the inertial torque to summer 160, would likewise increase the torque required during acceleration.

Of course, if the motor is decelerating, the inertial torque supplies energy, and reduces the amount of electrical energy which must be supplied to produce a given shaft torque. During a deceleration the negative sign on the input of the inertial torque to summer 160 adds additional torque to the torque command while during acceleration summer 160 subtracts additional torque from the torque command. This situation is inherently more stable than if torque was added during acceleration and subtracted during deceleration as would be the case if the sign on summer 160 were positive.

The summation includes feedback from the torque calculator 130. This calculator uses steady state relationships to provide an estimate of torque excluding any electrical transients. Of course, a torque error could be computed using only the torque command 135 and the torque calculator 130 while disregarding any input from inertial torque 140. However, it has been found that the system is more stable when the inertial torque is included in summer 160.

From one point of view, the sum of (1) the torque calculated by block 130 and (2) the torque demanded by block 135 can be viewed as a preliminary error signal. That preliminary error signal is then modified by the value of the inertial torque, if any to provide an improved error signal.

The error signal is delivered to block 170, which computes the voltage needed to provide the demanded torque. That voltage is delivered to an inverter 175, which is known in the art. The inverter is so-called because it “inverts” DC power, as from an automobile battery, into sinusoidal AC power. In the case of a two-phase motor 120, the inverter 175 produces two sine waves, ninety degrees apart. In the case of a three-phase motor, the inverter 175 produces three sine waves, 120 degrees apart.

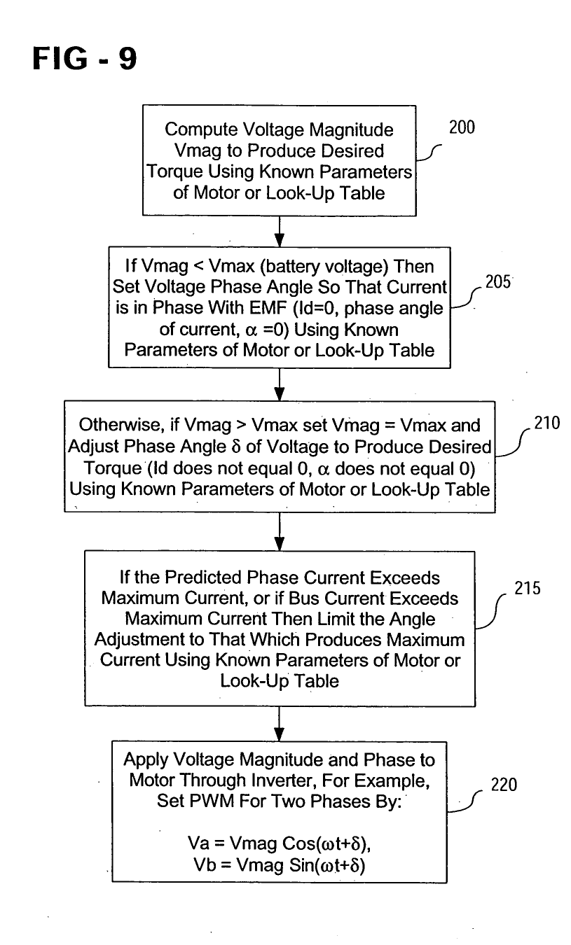

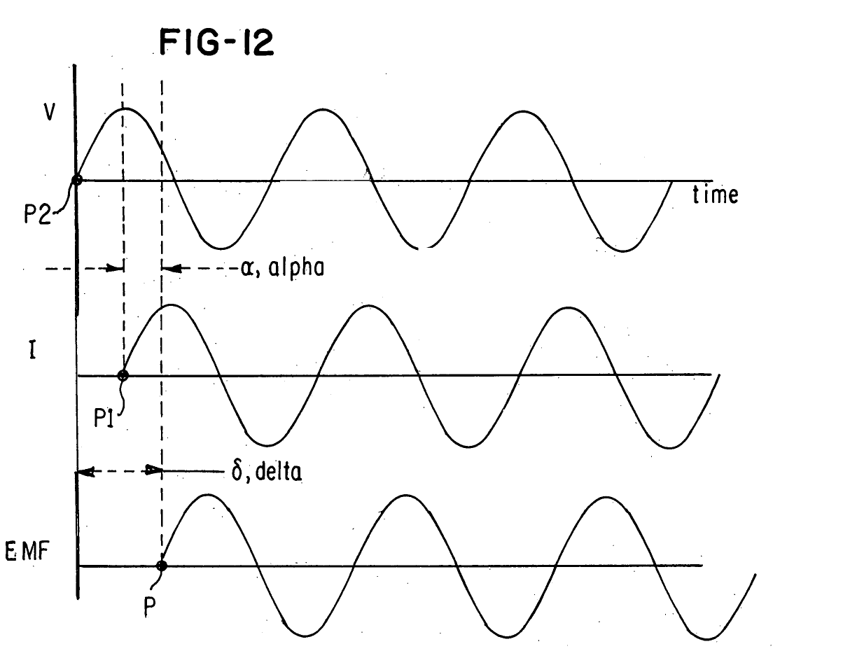

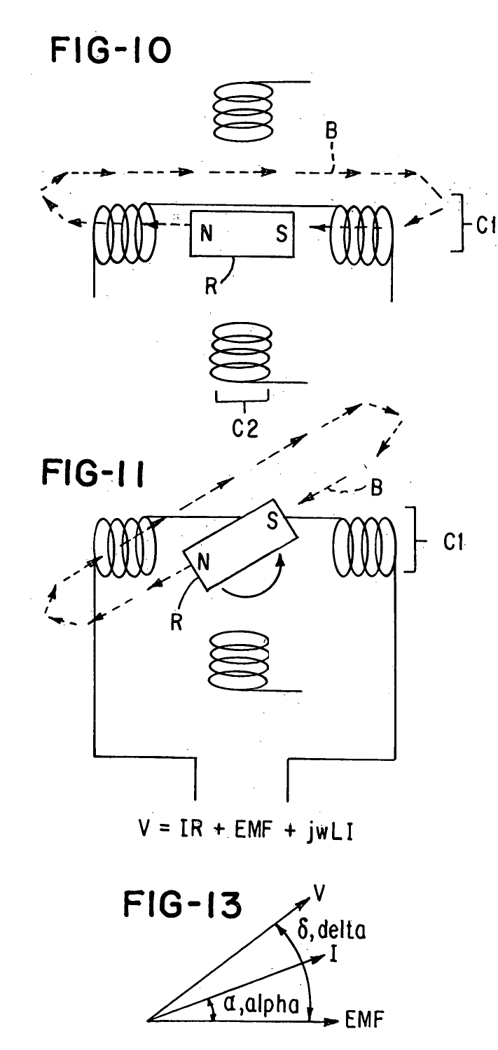

FIG. 9 illustrates processes implemented by voltage calculator 170 of FIG. 170. As background, to explain symbology used in FIG. 9, FIGS. 10-13 will be explained first. FIG. 10 illustrates two pairs of coils C1 and C2 present in a two-phase motor. A rotor R contains a permanent magnet, which produces a magnetic flux B. The rotor R rotates, as in FIG. 11.

The rotating flux B induces a voltage EMF, Electro Motive Force, in coil C1, as well as C2. The total voltage across the ends of the coil C1 can be said to contain the three components indicated: the EMF, the IR voltage drop, and the wLI term, wherein w is electrical frequency of the applied current, L is the inductance of the coil at that frequency, and I is the applied current. The IR term will be ignored in this context, because it is small.

The three voltages, namely, (1) the total voltage across the coil, (2) the EMF, and (3) the wLI term are approximately sinusoidal, as indicated in FIG. 12. Their magnitudes as indicated are arbitrary, since FIG. 12 is used to indicate that these terms can have different phases. EMF differs from V by phase delta. Current I differs from EMF by phase alpha.

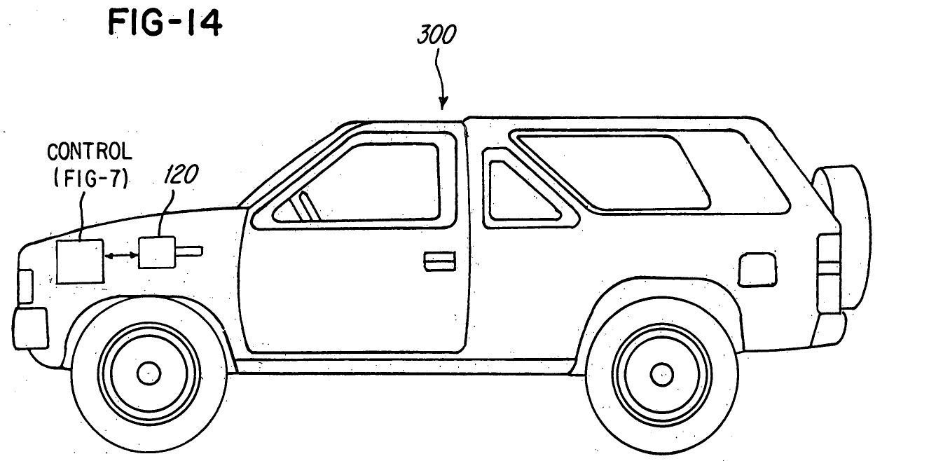

Since these terms are sinusoidal, they can be represented by phasor-vectors, as in FIG. 13. Phasor EMF is taken as a reference, at angle zero. The current, or wLI term, is taken as having an angle alpha with respect to EMF, as indicated. The voltage vector V is taken as having an angle delta with respect to EMF, as indicated.

Now the processes of FIG. 9 can be explained. Block 200 indicates that a voltage Vmag is first computed, which is the voltage needed to produce the presently desired torque. Equation 2 in FIG. 8 can be used to compute this voltage.

In FIG. 9, blocks 205 and 210 represent alternatives. In the case where the motor 120 in FIG. 7 is used in a vehicle, the power for the motor 120 most likely originates in a lead-acid battery. That battery has a limited voltage, such as 12 volts. Thus, the peak-to-peak voltage which inverter 175 in FIG. 7 can produce is limited.

Thus, if the voltage computed in block 200 in FIG. 9 falls below the available battery voltage, the alternative of block 205 is taken. In that alternative, the voltage magnitude computed in block 200 is used, or generated, by the inverter 175 in FIG. 7.

In addition, a phase angle delta is computed for the computed voltage. That phase angle delta is shown in FIG. 13. The phase angle delta is computed using equation 4 in FIG. 8 and, when so computed, has the property of reducing the phase angle alpha in FIG. 13 to zero.

That is, this phase angle delta, computed according to Equation 4 in FIG. 8, causes the current I to be in-phase with the induced EMF. Stated another way, the direct, d, component of the current shown in image 72 in FIG. 6 is driven to zero. The only component of current now present is at 90 degrees to the rotor magnetic field.

In the other alternative, if the voltage computed in block 200 in FIG. 9, that is, the voltage computed in Equation 2 in FIG. 8, exceeds the available battery voltage, then the process of block 210 in FIG. 9 is implemented. The computed voltage Vmag is set at the battery voltage, Vmax, which is the maximum voltage available. In addition, the needed phase angle delta is computed which will produce the desired torque. Equation 3 in FIG. 8 can be used for this purpose.

Blocks 205 and 210 can be recapitulated. First, Vmag is computed, which is the voltage magnitude needed for the desired torque. If Vmag can be supplied by the local power supply, then block 205 in FIG. 9 is implemented. Angle delta in FIG. 13 is computed according to Equation 4 in FIG. 8. This value of delta drives angle alpha in FIG. 13 to zero, making I in-phase with EMF.

In effect, in most cases, block 205 obtains any increase in required torque from an increase in voltage, leaving alpha unchanged at zero.

If Vmag cannot be supplied by the local power supply, then block 210 is implemented. Vmag is now set equal to the local power supply voltage. Angle delta in FIG. 13 is computed using equation 3 in FIG. 8. This will give angle alpha in FIG. 13 some value, thus producing a current on the d-axis in FIG. 6.

Block 215 in FIG. 9 imposes a limit. Current to be expected from the voltage applied is computed, as known in the art. If the current exceeds one or more limits, then the phase angle delta is further adjusted to keep the current within bounds.

Once Vmag and delta have been computed, the phase voltages for the two-phase motor are computed in block 220, and applied to the motor 120 in FIG. 7. It is repeated that, in block 220 in FIG. 9, Vmag has one of two values. If Vmag computed in Equation 2 in FIG. 8 exceeds the local supply voltage, then Vmag in block 220 is set equal to that local supply voltage (or whatever relevant maximum voltage is present). If the local supply voltage is not exceeded, then the Vmag computed in Equation 2 is used in block 220 in FIG. 9.

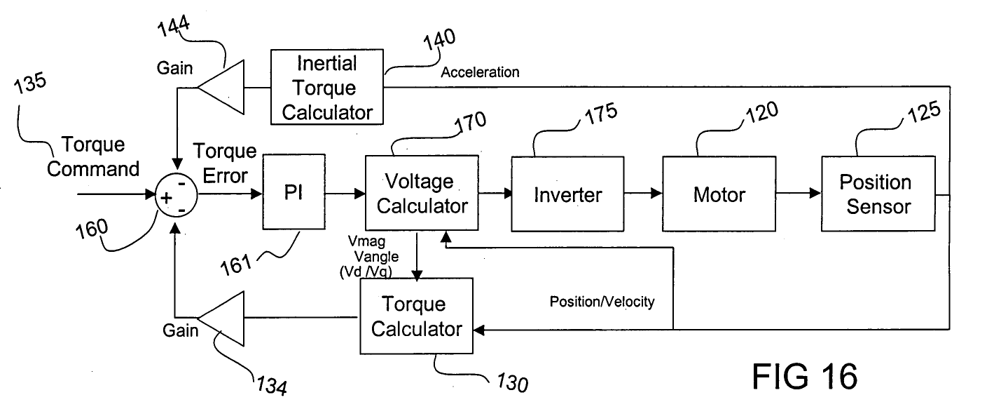

An alternative configuration for the control scheme is illustrated in FIG. 16. Gain 134 and 144 can be added in each of the feedback loops to improve stability. It is also possible to add a proportional-integral control 161 to facilitate minimization of the torque error.

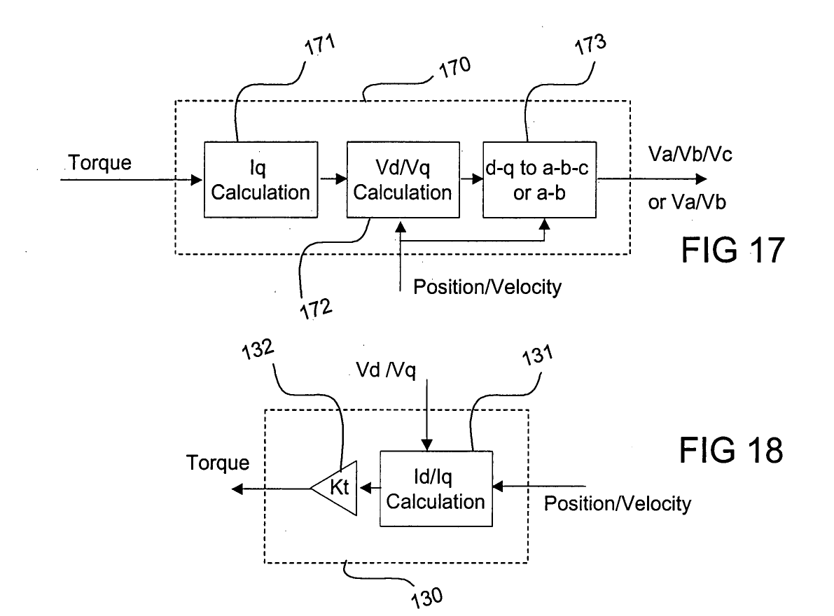

It is also possible to implement the voltage and torque calculation blocks using d and q rotationally transformed variables that allow the calculations to be made without the need for inverse trigonometric functions. The alternative voltage calculator 170, shown in FIG. 17, computes the required q-axis current from the torque command in 171. This current, together with the rotor velocity, current, and voltage constraints are used in 172 to compute the d and q axis voltage required to produce this current in steady state. In accordance with the algorithm of FIG. 9, the d-axis may need to be regulated if the voltage maximum is reached. The required voltages are transformed in 173 to the instantaneous values for a 2 phase or 3 phase inverter.

The alternative torque calculator, 130, is shown in FIG. 18. Knowing the d and q axis voltages from block 172 of FIG. 17, and the rotor velocity measured with a sensor, the q axis current are computed in 131. The current is multiplied by a torque constant in 132 to compute a steady state estimate of the torque.

Numerous substitutions and modifications can be undertaken without departing from the true spirit and scope of the invention. What is desired to be secured by Letters Patent is the invention as defined in the following claims.

What is claimed is:

1. A method of operating an electric motor in a vehicle, wherein
1) orthogonal d- and q-axes are definable on a rotor in the motor, with the d-axis being parallel with a magnetic field carried by the rotor, and
2) the motor receives power from a central power supply in the vehicle which has a system voltage, comprising:
a) receiving a demand for increased torque;
b) if system voltage allows an increase in voltage applied to the motor, then increasing motor voltage;
c) if system voltage does not allow an increase in voltage applied to the motor, then increasing magnetic field along the d-axis.

2. Method according to claim 1, wherein the voltage applied to the motor is held fixed in the process of paragraph (c).

3. Method according to claim 1, wherein (1) present torque is measured, in order to determine whether present torque meets the demanded torque and (2) present torque is measured without measuring stator currents.

4. Method according to claim 1, wherein (1) present torque is estimated, in order to determine whether present torque meets the demanded torque and (2) present torque is estimated without measuring stator currents.

5. Method according to claim 1, wherein the increase of voltage in the process of paragraph (b) is accompanied by no increase in magnetic field along the d-axis.

6. Method according to claim 5, wherein the magnetic field component of the stator along the d-axis is zero.

7. A method of operating an electric motor having a rotor carrying a magnetic field which is aligned along a rotor axis, comprising:
a) receiving a signal calling for increased torque;
b) if possible, increasing torque by increasing motor voltage, without generating additional magnetic field along the rotor axis; and
c) if increasing torque as in paragraph (b) is not possible, then increasing torque by increasing motor voltage to a maximum, and generating a magnetic field along the rotor axis.

8. Method according to claim 7, and further comprising:
d) measuring present torque without measuring any currents; and
e) comparing present torque with the signal, to produce a torque error signal.

9. Method according to claim 7, and further comprising:
d) estimating present torque without measuring any currents; and
e) comparing present torque with the signal, to produce a torque error signal.

10. A system for increasing torque delivered by a brushless DC electric motor having N stator phases, comprising:
a) a voltage source Vs; and
b) means for ascertaining whether voltage delivered to the motor is below Vs; and
i) if so, adjusting phase angle, magnitude, or both phase angle and magnitude of voltage applied to the phases; and
ii) if not, delivering Vs to the motor and adjusting phase angle of current in the phases to produce desired torque.

11. System according to claim 10, and further comprising:
c) ascertaining whether current to be delivered exceeds a limit and, if so, placing a limit on phase angle of the current, or magnitude of voltage, to thereby limit current delivered.

12. A system for controlling an electric motor having N phase coils, wherein a phasor voltage Vmag is applied to inputs of each coil, and Vmag includes a
1) component due to a phasor current I in the coil and
2) a component due to a phasor EMF within the coil which is induced by a rotating magnetic flux interacting with the coil, and wherein
3) a phase angle delta is definable between Vmag and EMF and
4) a phase angle alpha is definable between I and EMF, comprising:
a) means for receiving a signal indicating a demanded torque, and computing a voltage Vmag needed to produce the demanded torque;
b) means for ascertaining whether Vmag falls below a limit and,
i) if so, setting phase angle delta so that phase angle alpha is zero, and
ii) if not, setting phase angle alpha so that demanded torque is produced.

13. In an electric motor having N phase coils, wherein each phase coil exhibits a coil voltage V, which is a phasor and which includes (1) a phasor component due to a phasor current I in the coil and (2) a phasor component due to an induced EMF in the coil, a control method comprising:
a) computing a voltage Vmag which, when applied to the phase coils, produces a demanded torque;
b) ascertaining whether Vmag exceeds a limit Vs, and,
i) if so, computing a phase angle for V which causes current I to be in-phase with EMF; and
ii) if not, setting V equal to Vs, and computing a phase angle for V which produces the demanded torque.

14. In an electric motor having N phase coils, a method of increasing torque during operation, comprising:
a) if voltage V applied to the coils can be increased, then causing current in the coils to be in phase with induced EMF in the coils;
b) if V cannot be increased, then adjusting phase angle of V so that torque increases.

15. Apparatus, comprising:
a) a vehicle;
b) a steering assist linkage;
c) a two-phase brushless DC electric motor which delivers power to the assist linkage;
d) a control system for the electric motor, which includes
e) a sensor which senses angular position of the motor, and produces a position signal in response;
f) a first circuit which computes motor speed and motor acceleration using the position signals;
g) a second circuit which computes inertial torque of the motor;
h) a third circuit which computes presently delivered torque of the motor;
i) a torque computer which
i) receives a torque demand signal,
ii) determines error between presently delivered torque and the demanded torque, and
iii) adjusts the error based on inertial torque, to produce a corrected error;
j) means for computing instantaneous voltages needed to produce the torque demanded or reduce the corrected error, or both; and
k) means for producing and delivering voltages to the phases of the motor.

16. Apparatus for controlling an electric motor in a vehicle, wherein
1) orthogonal d- and q-axes are definable on a rotor in the motor, with the d-axis being parallel with a magnetic field carried by the rotor, and
2) the motor receives power from a central power supply in the vehicle which has a system voltage, comprising:
a) means for receiving a demand for increased torque;
b) means for increasing motor voltage if system voltage allows an increase in voltage applied to the motor;
c) means for increasing magnetic field along the d-axis, if system voltage does not allow an increase in voltage applied to the motor.

17. Apparatus according to claim 16, wherein the voltage applied to the motor is held fixed in the process of paragraph (c).

18. Apparatus according to claim 16, wherein (1) present torque is measured, in order to determine whether present torque meets the demanded torque and (2) present torque is measured without measuring stator currents.

19. Apparatus according to claim 16, wherein (1) present torque is estimated, in order to determine whether present torque meets the demanded torque and (2) present torque is estimated without measuring stator currents.

20. Apparatus according to claim 16, wherein the increase of voltage in the process of paragraph (b) is accompanied by no increase in magnetic field along the d-axis.

21. Apparatus according to claim 20, wherein the magnetic field along the d-axis is zero.

22. Apparatus for controlling an electric motor having a rotor carrying a magnetic field which is aligned along a rotor axis, comprising:
a) means for receiving a signal calling for increased torque;
b) means for either
i) increasing torque by increasing motor voltage, without generating additional magnetic field along the rotor axis; or
ii) increasing torque by increasing motor voltage to a maximum, and generating a magnetic field along the rotor axis.

23. Apparatus according to claim 22, and further comprising:
d) means for measuring present torque without measuring any currents; and
e) means for comparing present torque with the signal, to produce a torque error signal.

24. Apparatus according to claim 22, and further comprising:
d) means for estimating present torque without measuring any currents; and
e) means for comparing present torque with the signal, to produce a torque error signal.

25. Method for increasing torque delivered by a brushless DC electric motor having N stator phases and which is powered by a voltage source Vs, comprising:
a) ascertaining whether voltage delivered to the motor is below Vs; and
i) if so, adjusting phase angle of voltage applied to the phases; and
ii) if not, delivering Vs to the motor and adjusting phase angle of current in the phases to produce desired torque.

26. Method according to claim 10, and further comprising:
b) ascertaining whether current to be delivered exceeds a limit and, if so, placing a limit on phase angle of the current, to thereby limit current delivered.

27. A method for controlling an electric motor having N phase coils, wherein a phasor voltage Vmag is applied to inputs of each coil, and Vmag includes a
1) component due to a phasor current I in the coil and
2) a component due to a phasor EMF within the coil which is induced by a rotating magnetic flux interacting with the coil, and wherein
3) a phase angle delta is definable between Vmag and EMF and
4) a phase angle alpha is definable between I and EMF, comprising:
a) receiving a signal indicating a demanded torque, and computing a voltage Vmag needed to produce the demanded torque;
b) ascertaining whether Vmag falls below a limit and,
i) if so, setting phase angle delta so that phase angle alpha is zero, and
ii) if not, setting phase angle alpha so that demanded torque is produced.

28. In an electric motor having N phase coils, wherein each phase coil exhibits a coil voltage V, which is a phasor and which includes (1) a phasor component due to a phasor current I in the coil and (2) a phasor component due to an induced EMF in the coil, a control system comprising:
a) means for computing a voltage Vmag which, when applied to the phase coils, produces a demanded torque;
b) means for ascertaining whether Vmag exceeds a limit Vs, and,
i) if so, computing a phase angle for V which causes current I to be in-phase with EMF; and
ii) if not, setting V equal to Vs, and computing a phase angle for V which produces the demanded torque.

29. In an electric motor having N phase coils, a system for increasing torque during operation, comprising:
a) means for ascertaining whether voltage V applied to the coils can be increased, and, if so, causing current in the coils to be in phase with induced EMF in the coils;
b) means for ascertaining whether V cannot be increased, and, if so, adjusting phase angle of V so that torque increases.

30. A method of controlling a brushless DCI motor in a vehicle, comprising:
a) receiving a demanded torque signal;
b) estimating motor current using indirect current sensing;
c) comparing demanded torque with a computed torque which indicates presently delivered steady-state torque based on indirect current sensing, to produce a preliminary error signal;
c) adjusting the preliminary error signal in accordance with rotor inertial torque to produce a final error signal; and
d) causing the motor to reduce the final error signal.

31. A method of controlling a brushless DC motor in a vehicle, comprising:
a) receiving a demanded torque signal;
b) comparing demanded torque with a computed torque which indicates presently delivered steady-state torque, to produce a preliminary error signal;
c) adjusting the preliminary error signal in accordance with rotor inertial torque to produce a final error signal; and
d) causing the motor to reduce the final error signal.

32. Apparatus for controlling a brushless DC motor in a vehicle, comprising:
a) means for receiving a demanded torque signal;
b) means for comparing demanded torque with a computed torque which indicates presently delivered steady-state torque, to produce a preliminary error signal;
c) means for adjusting the preliminary error signal in accordance with rotor inertial torque to produce a final error signal; and
d) means for causing the motor to reduce the final error signal.

33. Apparatus for controlling a brushless DC motor in a vehicle, comprising:
a) means for receiving a demanded torque signal;
b) means for comparing demanded torque with a computed torque which indicates presently delivered steady-state torque, to produce an error signal;
d) means for causing the motor to reduce the error signal.

34. Apparatus for controlling a brushless DC motor in a vehicle, comprising:
a) means for receiving a demanded torque signal;
b) means for adjusting the demanded torque signal in accordance with rotor inertial torque to produce an adjusted demanded torque signal; and
c) means for causing the motor to produce the demanded torque.

35. Method according to claim 6, wherein the magnetic field along the d-axis comprises a stator magnetic field component.
